(19) United States
(12) Patent Application Publication
(10) Pub. No.: US 2014/0308236 A1
(43) Pub. Date: Oct. 16, 2014

(54) ANTIMICROBIAL COMPOSITION AND USES THEREOF

(71) Applicant: TECHNION RESEARCH AND DEVELOPMENT FOUNDATION LTD., Haifa (IL)

(72) Inventors: Havazelet BIANCO-PELED, Aloney Aba (IL); Maya DAVIDOVICH-PINHAS, Kiryat-Tivon (IL)

(21) Appl. No.: 14/146,113

(22) Filed: Jan. 2, 2014

Related U.S. Application Data
(60) Provisional application No. 61/749,980, filed on Jan. 8, 2013.

(51) Int. Cl. A01N 43/16

(52) U.S. Cl. CPC A01N 43/16
USPC 424/78.32; 536/20; 514/55; 526/238.2

(57) ABSTRACT

The present invention provides a composition including an antibacterial polymer bound to a synthetic water soluble polymer, methods of using the composition for avoiding bacterial growth and processes of making plastic material which include these antibacterial compositions.

### FIELD OF INVENTION

This invention is directed to; inter alia, antibacterial plastic, process of making antibacterial plastic and its use.

### BACKGROUND OF THE INVENTION

Antimicrobial modification of surfaces to prevent growth of detrimental microorganisms is a highly desired objective. Microbial infestation of hospital surfaces, medical implants and devices is one of the leading causes of nosocomial infection in patients. This often leads to life threatening complications in recuperating patients, whose immune system is already weakened by disease, trauma or medical treatment.

Surface-centered infections are also implicated in food spoilage, spread of food-borne diseases and bio-fouling of materials. Recent outbreaks of E. coli in fresh vegetables and Salmonella in peanut butter highlight the importance of maintaining sterility in all steps of the food supply chain, starting from harvesting, processing, packaging and final delivery. Moreover, due to the constant increase in standard of living, there has been a general increase in the expectation of people for a sterile bug/odor-free environment.

This has led to a growing commercial demand for materials capable of killing disease causing microbes found on everyday use surfaces like door handles, refrigerator surfaces, kitchen surfaces, toys, clothing, etc. Above all, from a scientific viewpoint there is a fundamental desire to comprehend what makes a polymer kill bacteria, and how its chemical structure influences its biocidal activity.

All of the above mentioned reasons have motivated researchers into developing biocidal functional materials, and investigating their structure antibacterial activity relationships.

There is extensive published literature on the fabrication, characterization and antibacterial property evaluation of antimicrobial materials and surfaces. The three broad classes of materials that have been used for making surfaces antimicrobial are: (a) Contact active amphiphilic polymers and peptide mimics, which kill bacteria by cell membrane disruption (Lee, S. B.; Koepsel, R. R.; Morley, S. W.; Matyjaszewski, K.; Sun, Y.; Russell, A. J. Biomacromolecules 2004, 5, 877-882), (b) Microbe repelling anti-adhesive polymers, which prevent cell/protein adhesion, (Lin, J.; Murthy, S. K.; Olsen, B. D.; Gleason, K. K.; Klibanov, A. M. Biotechnol. Lett. 2003, 25, 1661-1665), and (c) Polymeric/composite materials loaded with slow releasing biocides like heavy metals, antibiotics, small molecule biocides, halogens species, and nitric oxide (McDonnell, A. M. P.; Beving, D.; Wang, A.; Chen, W.; Yan, Y. Adv. Funct. Mater. 2005, 15, 336-340; Kohnen, W.; Kolbenschlag, C.; Keiser, S. T.; Jansen, B. Biomaterials 2003, 24, 4865-4869; .Iconomopoulou, S. M.; Voyiatzis, G. A. J. Controlled Release 2005, 103, 451-.464; Sun, Y.; Sun, G. Macromolecules 2002, 35, 8909-8912; Nablo, B. J.; Chen, T. Y; Schoenfisch, M. H. J. Am. Chem. Soc. 2001, 123, 9712-9713).

Chitosan has a limited ability to homogenously incorporate in plastic materials due to its hydrophilic characteristics. It is well known that most of plastic bulk materials such as polyolefin are hydrophobic in nature and therefore integrating hydrophilic polymers cause phase separation which will damage the material properties.

### SUMMARY OF THE INVENTION

In one embodiment, the present invention provides a composition including a thiolated antibacterial polymer having positive amine groups bound to a synthetic water soluble polymer via acrylated end groups of the synthetic water soluble polymer and the sulfide end groups on the thiolated antibacterial polymer. In another embodiment, the thiolated antibacterial polymer is thiolated chitosan. In another embodiment, the synthetic water soluble polymer is acrylated polyethylene glycol (PEGAc). In another embodiment, the synthetic water soluble polymer is poly(acrylic acid) (PAA) formed by in situ polymerization of acrylic acid in the presence of thiolated chitosan.

In another embodiment, the present invention further provides a packaging material wherein a composition including a thiolated antibacterial polymer having positive amine groups bound to an synthetic water soluble polymer via acrylated end groups of the synthetic water soluble polymer and the sulfide end groups on the thiolated antibacterial polymer is incorporated therein.

In another embodiment, the present invention further provides a process for the preparation of the composition including a thiolated antibacterial polymer having positive amine groups bound to a synthetic water soluble polymer, with the steps of: (a) thiolating antibacterial polymer having positive amine groups; and (b) reacting the resulting thiolated antibacterial polymer having positive amine groups with a synthetic water soluble polymer by Michael type addition reaction.

In another embodiment, the present invention further provides a process for the preparation of the composition including a thiolated antibacterial polymer having positive amine groups bound to a synthetic water soluble polymer, with the steps of: (a) thiolating antibacterial polymer having positive amine groups; (b) reacting the resulting thiolated antibacterial polymer having positive amine groups with acrylated synthetic water soluble monomers by Michael type addition reaction. (c) further polymerization by adding synthetic water soluble monomers to the reaction mixture to form in situ synthetic water soluble polymer bound to the thiolated antibacterial polymer.

In another embodiment, the present invention further provides a method for conferring antibacterial property to plastic including the step of mixing: (a) a plastic melt, (b) a plastic compatibilizer, and (c) a composition including a thiolated antibacterial polymer having positive amine groups bound to a synthetic water soluble polymer via the acrylated end groups of the synthetic water soluble polymer and the sulfide end groups on the thiolated antibacterial polymer.

### BRIEF DESCRIPTION OF THE DRAWINGS

FIG. 1. A thiolation scheme of an antibacterial polymer of the invention (such as chitosan).

FIG. 2. A graph showing ATR-FTIR spectra obtained from chitosan and thiolated chitosan.

FIG. 3. A graph showing thermal analysis of chitosan and thiolated chitosan using: DSC (3A) and TGA techniques (3B).

FIG. 4. A Schematic illustration of the chitosan-PEG synthesis.

FIG. 5. A graph showing the ATR-FTIR spectra obtained from chitosan, Chitosan-PEGAc and PEG-DA.

FIG. 6. A graph showing the thermal analysis of chitosan using: DSC (6A) and TGA techniques (6B).

### DETAILED DESCRIPTION OF THE INVENTION

In one embodiment, the present invention provides a composition comprising an antibacterial, polycation, polymer bound to a synthetic water soluble polymer. In another embodiment, the present invention provides a composition comprising an antibacterial polymer having positive amine groups bound to a synthetic water soluble polymer. In another embodiment, the present invention provides a composition comprising a thiolated antibacterial polymer having positive amine groups bound to an acrylated synthetic water soluble polymer via the acrylated end groups of the synthetic water soluble polymer and the sulfide end groups on the thiolated antibacterial polymer.

In another embodiment, an antibacterial polymer of the present invention is a polycation with primary ammonium. In another embodiment, an antibacterial polymer of the present invention is a polycation with phosphonium. In another embodiment, an antibacterial polymer of the present invention is a polycation with, tertiary sulfonium. In another embodiment, an antibacterial polymer of the present invention is a polycation with guanidinium. In another embodiment, an antibacterial polymer of the present invention comprises poly(hexamethylene biguanidinium hydrochloride). In another embodiment, an antibacterial polymer of the present invention comprises poly(methacrylate) that includes chlorhexidine-like side groups.

In another embodiment, an antibacterial polymer of the present invention comprises a polyallylamine. In another embodiment, an antibacterial polymer of the present invention comprises a polyamidoamine. In another embodiment, an antibacterial polymer of the present invention comprises a Poly[α-(4-aminobutyl)-L-glycolic acid]. In another embodiment, an antibacterial polymer of the present invention comprises a Poly(2-amioethyl propylene phosphate).

In another embodiment, an antibacterial polymer of the present invention comprises the structure of formula I:

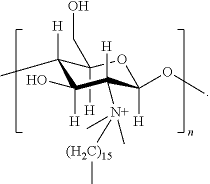

In another embodiment, an antibacterial polymer of the present invention comprises the structure of formula II:

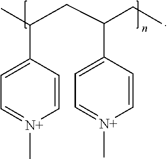

In another embodiment, an antibacterial polymer of the present invention comprises the structure of formula III:

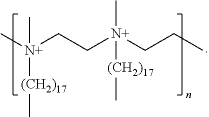

In another embodiment, an antibacterial polymer of the present invention comprises the structure of formula IV:

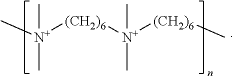

In another embodiment, an antibacterial polymer of the present invention comprises poly(phenylene ethynylene) which has amino side groups. In another embodiment, polymers with stiff backbones and cationic side groups are utilized as antibacterial polymers of the invention due to their high antimicrobial activity and low toxicity. In another embodiment, an antibacterial, polycation, polymer is a mimic for magainin.

In another embodiment, an antibacterial polymer of the present invention comprises protonated tertiary and primary amino groups. In another embodiment, an antibacterial polymer of the present invention comprises dimethylaminomethyl styrene. In another embodiment, an antibacterial polymer of the present invention comprises octylstyrene, which is antimicrobially active upon protonation of the tertiary amino groups. In another embodiment, an antibacterial polymer of the present invention comprises dimethylaminoethylacrylamide. In another embodiment, an antibacterial polymer of the present invention comprises aminoethylacrylamide. In another embodiment, an antibacterial polymer of the present invention comprises n-butylacrylamide. In another embodiment, an antibacterial polymer of the present invention comprises poly(diallylammonium) salts that comprise secondary and/or tertiary amino groups

In another embodiment, an antibacterial polymer of the present invention has only one biocidal end group. In another embodiment, an antibacterial polymer of the present invention is realized by cationic ring-opening polymerization of 2-alkyl-1,3-oxazolines and terminating the macromolecule with a cationic surfactant.

In another embodiment, an antibacterial polymer as described herein is thiolated. In another embodiment, the thiol group within the antibacterial polymer enables its binding to a water soluble polymer. In another embodiment, the synthesis of antibacterial polymer is performed via the Bernkop-Schnurch et al. method (A. Bernkop-Schnurch, M. Hornof, T. Zoidl, Int. J. Pharm., 260 (2003) 229-237). In another embodiment, thiolation of an antibacterial polymer is achieved by 2-iminothiolane conjugation. In another embodiment, the thiolated antibacterial polymer is also antifungal.

In another embodiment, the thiolated antibacterial polymer has a thiol content of 20 to 5000 μmole thiol/gr of an antibacterial polymer. In another embodiment, the thiolated antibacterial polymer has a thiol content of 50 to 5000 μmole thiol/gr of an antibacterial polymer. In another embodiment, the thiolated antibacterial polymer has a thiol content of 200 to 800 μmole thiol/gr of an antibacterial polymer. In another embodiment, the thiolated antibacterial polymer has a thiol content of 200 to 500 μmole thiol/gr of an antibacterial polymer. In another embodiment, the thiolated antibacterial polymer has a thiol content of 50 to 200 μmole thiol/gr of an antibacterial polymer. In another embodiment, the thiolated antibacterial polymer has a thiol content of 100 to 700 μmole thiol/gr of an antibacterial polymer. In another embodiment, the thiolated antibacterial polymer has a thiol content of 200 to 400 μmole thiol/gr of an antibacterial polymer. In another embodiment, the thiolated antibacterial polymer has a thiol content of 300 to 500 μmole thiol/gr of an antibacterial polymer. In another embodiment, the thiolated antibacterial polymer has a thiol content of 400 to 500 μmole thiol/gr of an antibacterial polymer.

In another embodiment, the antibacterial polymer is chitosan. In another embodiment, the thiolated antibacterial polymer is thiolated chitosan. In another embodiment, the antibacterial polymer is a polylysine. In another embodiment, the antibacterial polymer is a polyallylamine. In another embodiment, the antibacterial polymer comprises poly-L-lysine. In another embodiment, the antibacterial polymer comprises lysozyme. In another embodiment, the antibacterial polymer is further modified to provide an anchor group to be bound to the water soluble polymer.

In another embodiment, a synthetic water soluble polymer has solubility of at least 2 g/100 mL in water at room temperature. In another embodiment, a synthetic water soluble polymer has solubility of at least 5 g/100 mL in water at room temperature. In another embodiment, a synthetic water soluble polymer has solubility of at least 10 g/100 mL in water at room temperature. In another embodiment, a synthetic water soluble polymer has solubility of 5 g/100 mL to 90 g/100 in water at room temperature. In another embodiment, a synthetic water soluble polymer has solubility of 10 g/100 mL to 80 g/100 mL in water at room temperature. In another embodiment, a synthetic water soluble polymer has solubility of 15 g/100 mL to 80 g/100 in water at room temperature. In another embodiment, a synthetic water soluble polymer has solubility of 20 g/100 mL to 70 g/100 mL in water at room temperature. In another embodiment, a synthetic water soluble polymer has solubility of 20 g/100 mL to 60 g/100 mL in water at room temperature.

In another embodiment, a synthetic water soluble polymer is polyethylene glycol (PEG). In another embodiment, a synthetic water soluble polymer is a polyacrylic acid. In another embodiment, a synthetic water soluble polymer is a polyacrylic acid homopolymer. In another embodiment, a synthetic water soluble polymer is a polyacrylic acid polymer crosslinked with an allyl ether pentaerythritol, allyl ether of sucrose or allyl ether of propylene. In another embodiment, a synthetic water soluble polymer is a polyvinyl alcohol. In another embodiment, a synthetic water soluble polymer is polyaccryle amid. In another embodiment, a synthetic water soluble polymer is modified to provide an anchor group to be bound to the antibacterial polymer. In another embodiment, a synthetic water soluble polymer such as but not limited to PEG is acrylated.

In another embodiment, a composition of the invention further comprises plastic. In another embodiment, a composition of the invention further comprising plastic is in the form of a film. In another embodiment, a composition of the invention further comprising plastic is in the form of a pellet. In another embodiment, a composition of the invention further comprising plastic is in the form of a melt.

In another embodiment, a composition comprising plastic as described herein comprises 0.1-25% w/w of the antibacterial polymer bound to a synthetic water soluble polymer. In another embodiment, an antibacterial polymer is a polymer having positive amine groups. In another embodiment, an antibacterial polymer is an antibacterial thiolated polymer having positive amine groups. In another embodiment, a synthetic water soluble polymer is an acrylated synthetic water soluble polymer.

In another embodiment, plastic is synthetic or semi-synthetic organic moldable substance. In another embodiment, plastic is an organic polymer of high molecular mass. In another embodiment, plastic is synthetic. In another embodiment, plastic is derived from petrochemicals. In another embodiment, plastic is at least partially natural. In another embodiment, plastic comprises oxygen, sulfur, nitrogen, or any combination thereof

In another embodiment, plastic is acrylic. In another embodiment, plastic is polyester. In another embodiment, plastic is a silicone. In another embodiment, plastic a polyurethane. In another embodiment, plastic is a halogenated plastic. In another embodiment, plastic is a thermoplastic. In another embodiment, plastic is a thermosetting polymer. In another embodiment, plastic comprises polyethylene. In another embodiment, plastic comprises polypropylene. In another embodiment, plastic comprises polystyrene. In another embodiment, plastic comprises polyvinyl chloride. In another embodiment, plastic comprises polytetrafluoroethylene (PTFE). In another embodiment, plastic is semi-crystalline plastic such as: polyethylene, polypropylene, poly(vinyl chloride), polyamides (nylons), polyesters and polyurethanes. In another embodiment, plastic is amorphous, such as polystyrene and its copolymers, poly(methyl methacrylate), and thermosets. In another embodiment, plastic is a thermoset. In another embodiment, plastic is an elastomer. In another embodiment, plastic is biodegradable. In another embodiment, plastic is electrically conductive.

In another embodiment, a composition comprising plastic as described herein further comprises organic or inorganic compounds blended within. In another embodiment, a composition comprising plastic as described herein further comprises a filler. In another embodiment, a composition comprising plastic as described herein further comprises a stabilizing additive such as but not limited to a flammability inhibitor. In another embodiment, a composition comprising plastic as described herein further comprises a mineral such as but not limited to chalk. In another embodiment, a composition comprising plastic as described herein further comprises a reinforcing agent. In another embodiment, a composition comprising plastic as described herein further comprises a plasticizer. In another embodiment, a composition comprising plastic as described herein further comprises an oily compound that confer improved rheology. In another embodiment, a composition comprising plastic as described herein further comprises a colorant.

In another embodiment, a composition comprising plastic as described herein further comprises a plastic compatibilizer. In another embodiment, a plastic compatibilizer is an interfacial agent or surfactant that facilitates formation of uniform blends of the composition of the invention with desirable end properties. In another embodiment, a plastic compatibilizer is maleic anhydride.

In another embodiment, the plastic is polyethylene. In another embodiment, a plastic compatibilizer is an ethylene copolymer. In another embodiment, a plastic compatibilizer is ethylene acrylic acid. In another embodiment, a plastic compatibilizer is ethylene vinyl acetate.

In another embodiment, the plastic is polypropylene. In another embodiment, a plastic compatibilizer is propylene acrylic acid. In another embodiment, a plastic compatibilizer is propylene vinyl acetate. In another embodiment, a plastic compatibilizer comprises at least one component identical or chemically similar to the “plastic” utilized while the other is either identical or chemically similar to the “water soluble polymer”.

In another embodiment, the present invention includes a packaging material based on the plastic comprising composition as described herein. In another embodiment, the present invention includes a medical device wherein the plastic comprising components of the medical device comprise a composition as described herein. In another embodiment, the packaging material is intended to package food. In another embodiment, the packaging material is intended to package a drug. In another embodiment, the packaging material is intended to package any medicinal item. In another embodiment, the packaging material is intended to package any item intended to be in contact with an immune-compromised subject. In another embodiment, the packaging material is intended to package any item intended to be in contact with a baby.

In another embodiment, the present invention provides a process for the preparation of the composition as described herein, comprising the steps of: (a) thiolating antibacterial polymer having positive amine groups; and (b) reacting the resulting thiolated antibacterial polymer having positive amine groups with an acrylated synthetic water soluble polymer (ASWSP) by Michael type addition reaction.

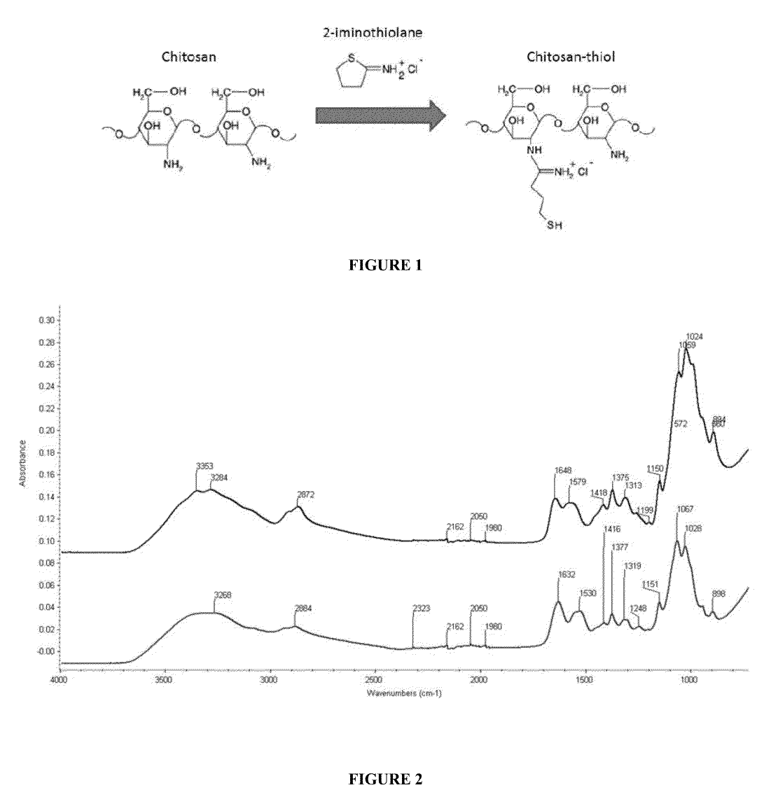

In another embodiment, the thiolated antibacterial polymer (TAP) is prepared by reacting an antibacterial polymer with 2-iminothiolane according to the Bernkop-Schnurch et al. protocol (see FIG. 1). In another embodiment, thiolation has led to several changes to the FTIR spectrum (FIG. 2).

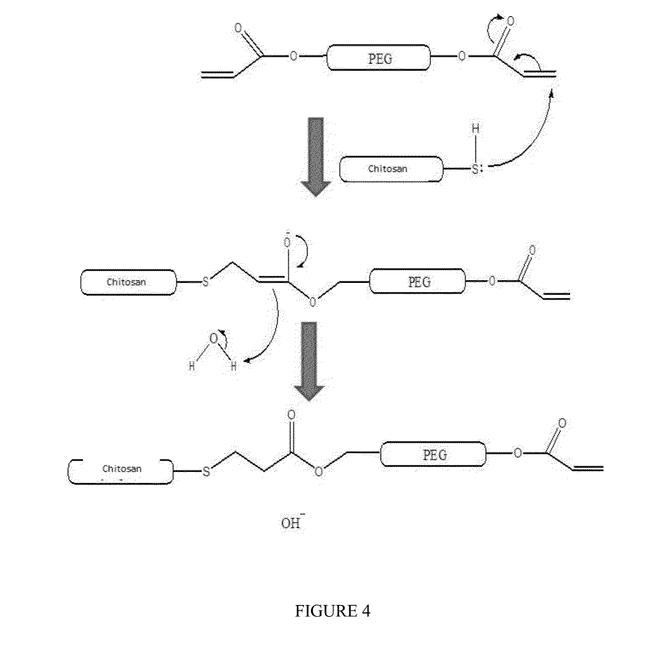

In another embodiment, the synthesis of TAP-ASWSP (FIG. 4) was adopted from a study on the PEGylation of polysaccharides (M. Davidovich-Pinhas, H. Bianco-Peled, Acta Biomat, 7 (2010) 625-633). In another embodiment, the synthesis of TAP-ASWSP involves the addition of ASWSP molecules to the TAP backbone through sulfide end groups by Michael type addition reaction. In another embodiment, this reaction occurs between the acrylated end groups on the ASWSP molecules and the sulfide end groups on the TAP backbone.

In another embodiment, the present invention provides a process for the preparation of the composition as described herein, comprising the steps of: (a) thiolating antibacterial polymer having positive amine groups; and (b) in situ polymerizing acrylic acid.

In another embodiment, in situ polymerizing acrylic acid comprises: Chitosan-TBA synthesis, chitosan-macromer synthesis, and chitosan-AA synthesis.

In another embodiment, Chitosan-TBA synthesis comprises: dissolving low molecular weight chitosan in acetic acid, adding 2-iminothiolane HCl (Traut's reagent) to the solution, adjusting the pH to 9.1-6.5, and incubating the reaction solution under stirring. In another embodiment, chitosan-macromer synthesis further comprises: adding EGDMA (Mw=198.22 gr/mol, density=1.051 gr/ml) using ×3 molar excess to the solution and incubating the reaction solution under stirring. In another embodiment, chitosan-AA synthesis synthesis comprises: purifying the solution with a filter or a membrane having 30 kDa molecular cut-off, nitriding the solution, adding 4 Ammonium Persulfate (APS) and Tetramethylethylenediamine (TEMED) to the reaction solution, adding acrylic acid, incubating the reaction solution under stirring, purifying the solution with a filter or a membrane having 30 kDa molecular cut-off, precipitating the product with acetone and separating the precipitate using a centrifuge, pouring access fluid and evaporating the remaining fluid, grinding the product, and washing remains of acrylic acid monomer.

In another embodiment, the present invention provides plastic material with antibacterial activity. In another embodiment, the present invention provides plastic material with antibacterial activity while overcoming the limited solubility of TAPs such as chitosan.

In another embodiment, the present invention provides a method for conferring antibacterial property to plastic comprising the step of mixing: (a) a plastic melt, (b) a plastic compatibilizer, and (c) a composition comprising a thiolated antibacterial polymer having positive amine groups bound to an acrylated synthetic water soluble polymer via the acrylated end groups of the synthetic water soluble polymer and the sulfide end groups on the thiolated antibacterial polymer. In another embodiment, conferring antibacterial property to plastic is preserving a packaged item within plastic and while cooling the resultant mixture, creating a plastic sheet, and packaging an item within a plastic sheet.

In another embodiment, packaged item is food. In another embodiment, packaged item comprises an organic molecule. In another embodiment, packaged item comprises a bacterial degradable material. In another embodiment, packaged item comprises a protein. In another embodiment, packaged item comprises a pharmaceutical or a nutraceutical. In another embodiment, packaged item comprises a carbon. In another embodiment, packaged item comprises oil. In another embodiment, packaged item comprises milk.

As provided hereinabove, in some embodiments, the plastic composition of the invention can be used in fabricating various medical devices. In another embodiment, a catheter comprises plastic composed of the composition of the present invention. In another embodiment, a prosthetic comprises plastic composed of the composition of the present invention. In another embodiment, an implant comprises plastic composed of the composition of the present invention. In another embodiment, a plastic composition as described herein prevents and/or inhibits surface microbial infestation that can result in serious infection and device failure. In another embodiment, a plastic composition as described herein prevents and/or inhibits surface-centered infections in food spoilage, spread of food-borne diseases and bio-fouling of materials.

In some embodiments, the antibacterial plastic compositions of the invention are used for applications in health and biomedical device industry, food industry and personal hygiene industry. In some embodiments, the antibacterial plastic compositions of the invention combine desirable attributes like potent antibacterial efficacy, environmental safety, low toxicity, and ease of fabrication.

In some embodiments, the antibacterial plastic compositions of the invention are used in sports and recreation equipment. In another embodiment, the antibacterial plastic compositions of the invention are used in food/pharmaceutical processing and handling machinery. In another embodiment, the antibacterial plastic compositions of the invention are used in machines and consumer appliances. In another embodiment, the antibacterial plastic compositions of the invention are used in general household goods. In another embodiment, the antibacterial plastic compositions of the invention are used in textile films and/or fibers. In another embodiment, the antibacterial plastic compositions of the invention are used in transportation interiors. In another embodiment, the antibacterial plastic compositions of the invention are used in construction supplies

In another embodiment, antimicrobial modification of plastic comprising compositions, as described herein, prevents growth of detrimental microorganisms and bacteria. In another embodiment, antimicrobial modification of plastic comprising compositions, as described herein, prevents microbial/bacterial infestation of plastic surfaces such as but not limited to hospitals. In another embodiment, antimicrobial modification of plastic comprising compositions, as described herein, prevents microbial/bacterial infestation in medical implants and devices comprising plastic. In another embodiment, antimicrobial modification of plastic comprising compositions, as described herein, prevents nosocomial infections in patients (and particularly patients that are immunocompromised such as babies, AIDS patients, or patients, whose immune system is already weakened by disease, trauma or medical treatment).

In another embodiment, antimicrobial modification of plastic comprising compositions, as described herein, prevents surface-centered infections. In another embodiment, antimicrobial modification of plastic comprising compositions, as described herein, prevents food spoilage. In another embodiment, antimicrobial modification of plastic comprising compositions, as described herein, prevents spread of food-borne diseases. In another embodiment, antimicrobial modification of plastic comprising compositions, as described herein, prevents bio-fouling of plastic comprising materials.

In one embodiment, antimicrobial modification of plastic comprising compositions, as described herein, prevents outbreaks of E. coli in fresh vegetables. In another embodiment, antimicrobial modification of plastic comprising compositions, as described herein, prevents outbreaks of Salmonella in peanut butter, eggs or meat. In another embodiment, antimicrobial modification of plastic comprising compositions, as described herein, prevents odor resulting from bacterial metabolism and/or respiration.

In one embodiment, antimicrobial modification of plastic comprising compositions, as described herein, renders plastic materials, capable of killing disease causing microbes found on everyday use surfaces like door handles, refrigerator surfaces, kitchen surfaces, toys, clothing, etc. In one embodiment, antimicrobial modification of plastic comprising compositions, as described herein, renders plastic materials, biocidal materials.

In one embodiment, antimicrobial plastic comprising compositions, as described herein, are contact active amphiphilic polymers and peptide mimics, which kill bacteria by cell membrane disruption. In one embodiment, antimicrobial plastic comprising compositions, as described herein, include microbe repelling anti-adhesive polymers. In one embodiment, antimicrobial plastic comprising compositions, as described herein, are further loaded with slow releasing biocides such as but not limited to: heavy metals, antibiotics, small molecule biocides, halogens species, and nitric oxide. In one embodiment, the present invention, unexpectedly, overcomes hurdles associated with the fact that plastic bulk materials such as polyolefin are hydrophobic in nature and therefore integrating hydrophilic antimicrobial polymers cause phase separation which will.

Unless otherwise stated, the following terms used in this application, including the specification and claims, have the definitions given below. It must be noted that, as used in the specification and the appended claims, the singular forms “a,” “an” and “the” include plural referents unless the context clearly dictates otherwise. In this application, the use of “or” or “and” means “and/or” unless stated otherwise. Furthermore, use of the term “including” as well as other forms, such as “have”, “having”, “include”, “includes,” and “included,” is not limiting. The section headings used herein are for organizational purposes only and are not to be construed as limiting the subject matter described.

The term “subject” or “patient” encompasses mammals. Examples of mammals include, but are not limited to humans, chimpanzees, apes, monkeys, cattle, horses, sheep, goats, swine, rabbits, dogs, cats, rats, mice, guinea pigs, and the like. In one embodiment, the mammal is a human.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Generally, the nomenclature used herein and the laboratory procedures utilized in the present invention include chemical, molecular, biochemical, and cell biology techniques. Such techniques are thoroughly explained in the literature. See, for example, “Molecular Cloning: A laboratory Manual” Sambrook et al., (1989); “Current Protocols in Molecular Biology” Volumes I-III Ausubel, R. M., ed. (1994); “Cell Biology: A Laboratory Handbook”, Volumes I-III Cellis, J. E., ed. (1994); The Organic Chemistry of Biological Pathways by John McMurry and Tadhg Begley (Roberts and Company, 2005); Organic Chemistry of Enzyme-Catalyzed Reactions by Richard Silverman (Academic Press, 2002); Organic Chemistry (6th Edition) by Leroy “Skip” G Wade; Organic Chemistry by T. W. Graham Solomons and, Craig Fryhle. Antimicrobial Polymers. 1. Edition February 2012, ISBN 978-0-470-59822-1. John Wiley & Sons.

### Material and Methods

Materials:

Chitosan medium molecular weight (MW) was purchased from sigma, Israel. 2-iminothiolane was purchased from ProteoChem, Denver, USA. PEG-DA was synthesized in Prof. Seliktar lab at the Biomedical Engineering Department, Technion.

Methods:

IR spectrums of the native, intermediate and final products were collected using ATR-FTIR Nicolet 6700 instrument. The measurements were taken using 64 scans with 4 cm⁻¹ spectral resolution. Thermal analysis of native, thiolated and PEGylated chitosan was performed using differential scanning calorimetry (DSC) as well as thermal gravimetry analyzer (TGA) instrument. DSC experiments were performed using samples of 2-4 mg sealed in an aluminum pan with high sensitivity DSC1 (Mettler Toledo) using a heating rate of 20° C./min under a nitrogen flow of 50 ml/min in the temperature range of 25-400° C. Decomposition profiles of dry samples were obtained with TA Q5000 thermal gravimetry analyzer using a heating rate of 20° C./min under air flow of 100 ml/min in the temperature range of 25-800° C.

### Example 1

### Synthesis and Characterization of Thiolated Chitosan

The synthesis of thiolated chitosan (FIG. 1) was adopted from Bernkop-Schnurch et al.

The structure of native chitosan and its derivatives were analyzed using FTIR-ATR spectroscopy. The spectrum of native chitosan reveal several characteristics peaks located at 3353 cm⁻¹ (O—H stretching), 3284 cm⁻¹ (N—H stretching), 2872 cm⁻¹ (C—H stretching), 1648-1579 cm⁻¹ (N—H deformation), 1418-1199 cm⁻¹ (C—H and O—H deformation vibration), 1150-894 cm⁻¹ (alcohol C—O and C—O—C bridge stretching). Similar results were obtained by several groups working with Chitosan. The N—H stretching peak at 3284 cm⁻¹ could be attributed to both primary and secondary amines. The N—H deformation amine peaks could be divided into free primary (1648 cm⁻¹) and secondary (1579 cm⁻¹) amines which can be attributed to chitosan C₂ position NH₂ group and chitin NH group, respectively. This results indicating that indeed the chitosan sample is not fully deacetylated.

Chitosan thiolation has not led to a significant change to the FTIR spectrum, as can be seen in FIG. 2. The same characteristics vibration peaks located at 3353 cm⁻¹ (0-H stretching), 2884 cm⁻¹ (C—H stretching), 1632-1530 cm⁻¹ (primary and secondary amine N—H deformation), 1416-1248 cm⁻¹ (C—H and O—H deformation) and 1151-898 cm⁻¹ (C—O and C—O—C bridge stretching) could be found in the thiolated chitosan. However some differences could be identified where the N—H stretching vibration peak at around 3300 cm⁻¹ disappeared and a new peak located at 2323 cm⁻¹ appeared. Such a behavior could be a result of the 2-iminothiolane conjugation. The synthesis of thiolated chitosan is based on the addition of 2-iminothiolane to the chitosan backbone through the primary amino group located at C₂ position. Such interaction leads to changes in the chitosan native amine type, from primary to secondary amine, a process that could cause the N—H stretching peak to disappear due to weaker intensity of the secondary amine. While the conjugation leads to the addition of new secondary positively charged amino group which is found to absorb at approximately 2323 cm⁻¹.

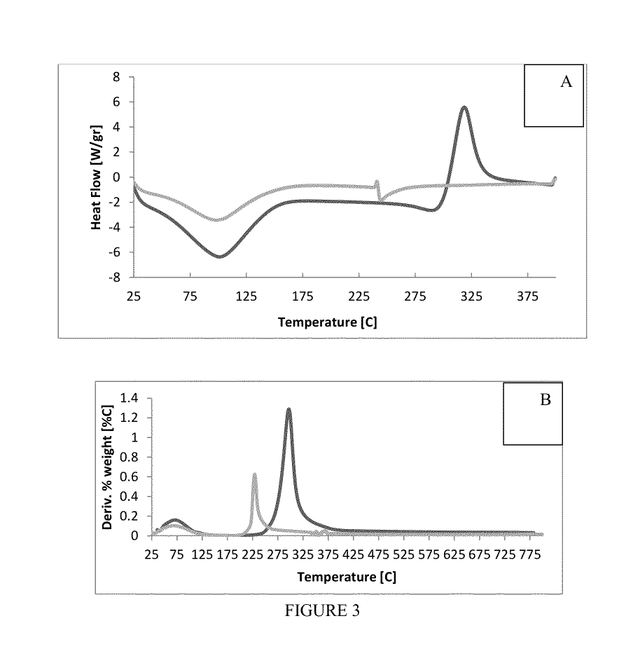

Thermal analysis of native and thiolated chitosan was conducted using DSC and TGA techniques. FIG. 3 shows the heat flow and decomposition curves obtained from the above materials. All thermograms reveal one dehydration step of up to 150° C. followed by additional thermal event. Chitosan sample have exhibited exothermic event at 318° C. in the DSC and one decomposition event at 296° C. in the TGA. Both events represent the same thermal property which was shifted due to difference in analysis instruments and experimental conditions. Several studies have examined the thermal behavior of chitosan and presented diverse decomposition temperatures in the range of 250-313° C. and 300-340° C. in the TGA and DSC, respectively.

Shift in the decomposition step between both thermal techniques was also detected in the thiolated chitosan sample where a temperature of 245° C. in the DSC and 229° C. in the TGA were determined. However, the thermal event was shifted to lower temperature and was characterized as an endothermic event, opposite from the chitosan behavior. TGA analyses of thiolated chitosan presented by others have demonstrated diverse results with regard to the difference between the native and thiolated chitosan. Radhakumary et al. detected a shift in the decomposition step to lower temperature after thiolation and correlate it to thermal destabilization of the polymer chains due to dissociation of the strong intra-molecular hydrogen bonding occur at the native form which were interfered in the thiolated form. On the other hand Wu et al. and Teng et al. have concluded that thiol modification did not affect chitosan's thermal stability.

The thiol content in the product was analyzed using Ellman's reagent procedure and a concentration of 350±40 μmole thiol/gr polymer was determined.

### Example 1

### Synthesis of Chitosan-AA

The below protocol was used for synthesizing chitosan-AA:

### Protocol for Synthesis:

### Step 1: Chitosan-TBA Synthesis

1. 5 gram of low molecular weight chitosan was dissolved in 2 liter of 2% acetic acid for 1-2 hr.
2. 0.5 gr of 2-iminothiolane HCl (Traut's reagent) was added to the solution.
3. The pH was adjusted to 6.3 using 5M NaOH.
4. The reaction solution was incubated under stirring for 24 hr.

### Step 2: Chitosan-Macromer Synthesis:

5. EGDMA (Mw=198.22 gr/mol, density=1.051 gr/ml) was added using ×3 molar excess, 1.15 ml EGDMA (calculated from the thiol content).
6. The reaction solution was incubated under stirring for 24 hr.

### Step 3: Chitosan-AA Synthesis:

7. The reaction solution was purified with filter membrane having 30 kDa molecular cut-off using Peristaltic pump for 1 hr.
8. Nitriding for about 15 min was performed with nitrogen gas.
9. 4 gr of Ammonium Persulfate (APS) and 18 ml of Tetramethylethylenediamine (TEMED) were added to the reaction solution.
10. 500 ml of acrylic acid (monomer) were added and the reaction solution was incubated in sealed container under stirring for 24 hr.
   steps 9 and 10 must be accomplished fast immediately after nitriding!
11. The reaction solution was purified again with filter membrane having 30 kDa molecular cut-off using Peristaltic pump for 1 hr.
12. The product was precipitated using 4 liters of acetone without stirring.
13. The precipitate was separated using a centrifuge for 6 min at 3600 rpm.
14. Access fluid was discarded and the remaining fluid was evaporated in a fume hood, or in an oven.
15. Upon drying the product was grinded to powder.
16. In order to wash any remains of acrylic acid monomer. 500 ml of acetone were added to the dry product powder and the mixture was stirred for 15 min. The precipitate was collected using the centrifuge at the same manner as section 14. The wash procedure was repeated three times.
17. The final clean product was grinded again.

### Example 2

### Synthesis and Characterization of Chitosan-PEGAc

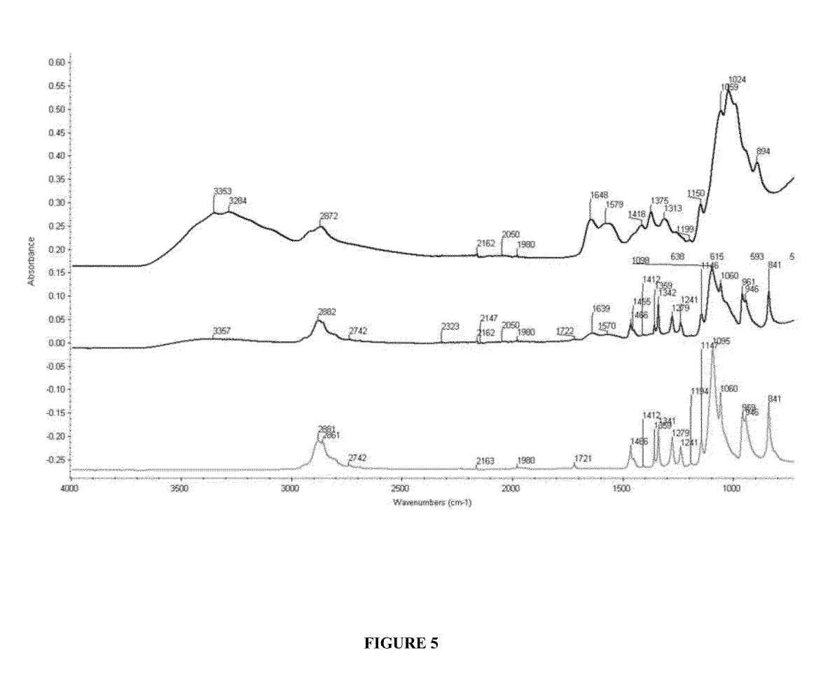

Synthesis of chitosan-PEGAc (FIG. 4) involved the addition of PEGAc molecules to the chitosan backbone through sulfide end groups by Michael type addition reaction. This reaction occurred between the acrylated end groups on the PEG-DA molecules and the sulfide end groups on the thiolated chitosan backbone. Therefore the expected FTIR characteristics are footprint arising from both the thiolated chitosan and the PEG-DA peaks. FIG. 5 represents the FTIR-ATR spectra obtained from chitosan-PEGAc and PEG-DA, respectively. Similar characteristics vibration peaks located at 3357 cm⁻¹ (0-H stretching), 2882 cm⁻¹ (C—H stretching), 1639-1570 cm⁻¹ (primery and secondary amine N—H deformation), 1455-1241 cm⁻¹ (C—H and O—H deformation) and 1146-841 cm⁻¹ (C—O and C—O—C bridge stretching) could be found in the PEGylated chitosan. The secondary positively charged amino group at 2323 cm⁻¹ was also identified. However, new peak located at 1722 cm⁻¹ was detected. Looking at the PEG-DA's FTIR-ATR spectra reveal the same peak at 1721 cm⁻¹, it seems that this peak belong to the vibration of the vinyl double bond. Comparison of the FTIR-ATR spectra of PEG-OH and PEGDA having the same molecular weight strengthen the assumption (data not shown). These polymers share the same repeating unit however differ in the polymer chemical end group where PEG-OH consist hydroxyl end group rather than acrylated end group in PEG-DA. This difference could be identified in the FTIR-ATR spectra where additional peak located at 1721 cm⁻¹ was detected in the PEG-DA sample while all other peaks were similar for both samples. This new peak can be correlated to the acrylated vinyl end group.

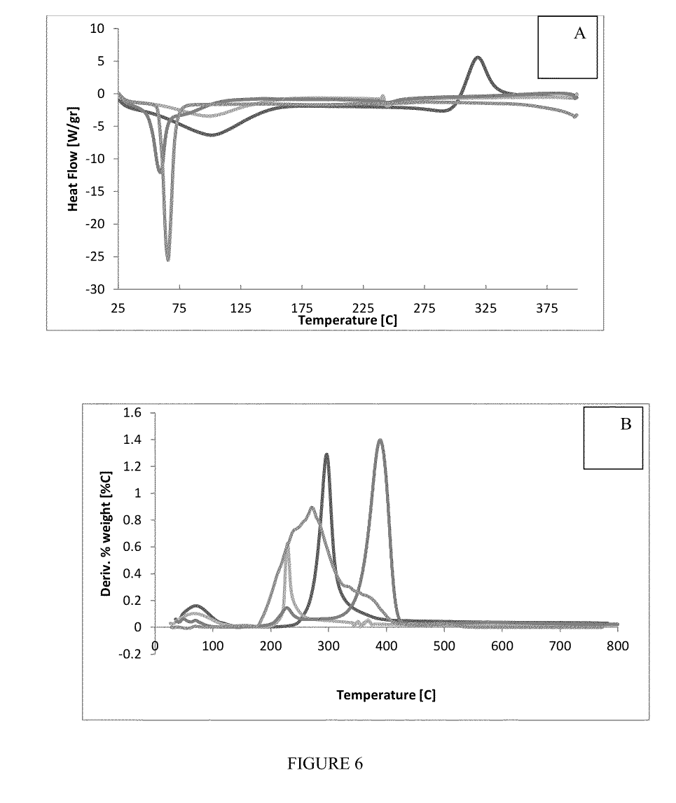

FIG. 6 shows the thermal analysis of chitosan-PEGAc reveal new characteristic peaks. In the DSC thermogram the experiment identified the PEG's characteristic melting temperature located at 66° C. and at 60° C. in native PEG-DA and chitosan-PEGAc, respectively. Diverse values of PEG's melting temperature Tm in the range of 58-88° C. can be found in the literature depending on its chemical environment. Alginate-PEO blends have demonstrated a decrease in PEG's Tm with the increase in alginate content from 67° C. to 62° C. and 60° C. to 58° C. While increase in PEG content in chitosan-PEG linear copolymers have caused an increase in PEG's Tm in the range of 61-88° C. Therefore, it can be concluded that the presence of polysaccharide, chitosan or alginate, causes a reduction in Tm of the PEG's chains. Water dehydration in this case can be correlated to the PEG's peak broadening on its right side. This broadening occurs in temperature range of up to 100° C. which is equivalent to the dehydration process.

The chitosan-PEGAc sample exhibited two characteristic decomposition steps which can be identify in the TGA curve. The first decomposition step can be identified in both DSC and TGA analysis at 245° C. and 227° C., respectively. This step has the same characteristics as the thiolated chitosan decomposition step suggesting that the PEGylation addition did not change the thermal stability of the original polymer backbone used for the synthesis. The second decomposition step located at 389° C. was identified only at the TGA curve due to the lower temperature range used in the DSC. This thermal event can be correlated to PEG's chain decomposition as identified in both Teng et al. and Neto et al. at 380° C. and 405° C., respectively. It seems that PEG-DA at its native form exhibit a different peak temperature and shape. However, while attached to the chitosan backbone it demonstrated similar properties as PEG chains.

### Example 3

### Chitosan-PEGAc has Antibacterial Activity

The bacteria used in this study were Escherichia coli ATCC 8739. A loop full of bacteria stored at −80° C., was directly inoculated in 3 ml Nutrient Broth (NB, Fluka) medium at 37° C. over night.

### Antibacterial Activity

The antibacterial activity of chitosan medium MW and chit-PEG med MW b1 (1 mg/ml media) was evaluated in 24 well plate containing overnight broth cultures diluted to 1:100 NB and adjusted to a concentration of 10⁵ CFU/ml (1 ml). The plates were incubated at 37° C. under agitation (100 rpm) and after 24 h samples were serially diluted in NB 1:100 (performed in 96 well plates) and 20 ml drops were incorporated into NB bacto-agar (Becton Dickinson) plates to determine cell number. Plates were incubated at 37° C. for 18-24 h, CFU were counted and log reduction was calculated in comparison to control growth of E. coli in NB 1:100 medium (10⁸ CFU/ml). All determinations were performed in duplicate including the growth controls.

### Results

Antimicrobial activity was tested in two separated experiments. Chitosan medium MW reduced the number of E. coli viable cells by approximately 5 and 6 log CFU. Chitosan-PEG med MW b1 totally reduced the number of E. coli viable cells by 8 log CFU indicating that Chitosan-PEG has unexpectedly enhanced bactericidal activity.

### Antibacterial Activity in Coated Films

The antibacterial activity of polymeric films PE-320 (1.2 cm diameter) with or without 3% Chit-PEG low MW b12 was evaluated in 24 well plate containing overnight broth cultures diluted to 1:300 NB and adjusted to a concentration of 10⁴ CFU/ml (1 ml). The plates were incubated at 37° C. under agitation (100 rpm) and after 24 h samples were serially diluted in NB 1:100 (performed in 96 well plates) and 20 ml drops were incorporated into NB bacto-agar (Becton Dickinson) plates to determine cell number. All plates were incubated at 37° C. for 18-24 h, CFU were counted and log reduction was calculated in comparison to control growth of E. coli in NB 1:300 medium (generally 10⁷ CFU/ml). All determinations were performed in duplicate including the growth controls.

TABLE 1
antibacterial activity of chitosan and chitosan -PEG

| | | | | | Level of |
|---|---|---|---|---|---|
| | Sample | E. Coli | Bacterial | replica- | bacterial |
| Material | solvent | growth | reduction | tions | reduction |
| Chitosan | 1% acetic | 0 | 10\hat{ }8 | 6 | HIGH |
| medium MW | acid | | | | |
| Chitosan-PEG | 1% acetic | 0 | 10\hat{ }8 | 6 | HIGH |
| based medium | acid | | | | |
| MW chitosan | | | | | |
| Chitosan | Growth | 10\hat{ }2 | 10\hat{ }5-10\hat{ }6 | 4 | MEDIUM |
| medium MW | media | | | | |
| Chitosan-PEG | Growth | 0 | 10\hat{ }7-10\hat{ }8 | 4 | HIGH |
| based medium | media | | | | |
| MW chitosan | | | | | |

What is claimed is:

1. A composition comprising a thiolated antibacterial polymer having positive amine groups bound to an acrylated synthetic water soluble polymer via the acrylated end groups of the synthetic water soluble polymer and the sulfide end groups on the thiolated antibacterial polymer.

2. The composition of claim 1, wherein said thiolated antibacterial polymer is thiolated chitosan.

3. The composition of claim 1, wherein said acrylated synthetic water soluble polymer is acrylated polyethylene glycol (PEGAc).

4. The composition of claim 1, wherein said acrylated synthetic water soluble polymer is a polyacrylic acid.

5. The composition of claim 1, wherein said thiolated antibacterial polymer has a thiol content of 20 to 5000 μmole thiol/gr antibacterial polymer.

6. The composition of claim 1, further comprising plastic.

7. The composition of claim 1, further comprising a plastic compatibilizer.

8. The composition of claim 7, wherein said plastic compatibilizer is an ethylene copolymer or a propylene acrylic acid.

9. The composition of claim 6, wherein said composition comprises 0.1-25% w/w of said thiolated antibacterial polymer having positive amine groups bound to an acrylated synthetic water soluble polymer.

10. A packaging material comprising the composition of claim 1.

11. A process for the preparation of the composition of claim 1, comprising the steps:
(a) thiolating antibacterial polymer having positive amine groups; and
(b) reacting the resulting thiolated antibacterial polymer having positive amine groups with an acrylated synthetic water soluble polymer by Michael type addition reaction.

12. A process for the preparation of the composition of claim 1, comprising the steps:
(a) thiolating antibacterial polymer having positive amine groups; and
(b) in situ polymerizing acrylic acid.

13. The process of claim 11, wherein said antibacterial polymer is chitosan.

14. The process of claim 11, wherein said acrylated synthetic water soluble polymer is PEGAc.

15. The process of claim 11, wherein said acrylated synthetic water soluble polymer is a polyacrylic acid.

16. A method for conferring antibacterial property to plastic comprising the step of mixing: (a) a plastic melt, (b) a plastic compatibilizer, and (c) a composition comprising a thiolated antibacterial polymer having positive amine groups bound to an acrylated synthetic water soluble polymer via the acrylated end groups of the synthetic water soluble polymer and the sulfide end groups on the thiolated antibacterial polymer.

17. The method of claim 16, wherein said plastic is adapted for food packaging.

18. The method of claim 16, wherein said plastic is adapted for drug packaging.

19. The method of claim 16, wherein said plastic is a component within a medical device.

20. The method of claim 16, wherein said conferring antibacterial property to said plastic is preserving a packaged item within plastic and said method further comprises cooling the resultant mixture of claim 19, creating a plastic sheet, and packaging said item within said plastic sheet.

21. The method of claim 16, wherein said thiolated antibacterial polymer is thiolated chitosan.

22. The method of claim 16, wherein said acrylated synthetic water soluble polymer is PEGAc.

23. The method of claim 16, wherein said acrylated synthetic water soluble polymer is a polyacrylic acid.

24. The method of claim 16, wherein said thiolated antibacterial polymer has a thiol content of 20 to 5000 μmole thiol/gr.

25. The method of claim 16, wherein said plastic compatibilizer is an ethylene copolymer or a propylene acrylic acid.

26. The process of claim 12, wherein said antibacterial polymer is chitosan.
